(19) United States
(12) Patent Application Publication
(10) Pub. No.: US 2003/0110165 A1
(43) Pub. Date: Jun. 12, 2003

(54) Method of and apparatus for sparse data table searching using limited inputs

(76) Inventors: Thomas D. Selgas, Garland, TX (US); Anna Sturdivant, Allen, TX (US); Mauro Hauptmann, Plano, TX (US)

Correspondence Address: CARR & STORM, L.L.P., 67 Founders Square, 900 Jackson Street, Dallas, TX, 75202, US

(21) Appl. No.: 10/016,600

(22) Filed: Dec. 10, 2001

(51) Int. Cl. G06F 7/00

(52) U.S. Cl. 707/3

(57) ABSTRACT

A set of rules is formulated for what type of data may be missing from a record (in a sparse data database) and still be desirably included in a search result when a search engine having limited inputs is used. In other words, under what conditions may data in a non-specified (non-specifically searched) database field be used as a substitute for null values in a field directly corresponding to a field in a limited search value input box. These rules are then used by a search engine to generate a complex criteria statement which retrieves not only the records directly corresponding to the search request values input by a user, but also those additional records which logically may comply if all the data fields were filled.

### TECHNICAL FIELD

The invention relates generally to databases and, more particularly, to retrieving sparsely populated records from a database using limited input criteria.

### BACKGROUND

The database community has often used similar or the same terminology to refer to different aspects of a database and any associated search engine. Further, at times, similar or identical terminology has been used to refer to different aspects of a single associated set of database tables. Thus, a plurality of definitions of terms will be set forth that will be used throughout the remainder of this document.

An input box, as used herein, comprises an area in a search engine display (user interface) where user entered search criteria or input property values are inserted. Typically an input box will have an associated input property label. A user may enter a simple input property value into the input box, may leave it empty (a null) and/ or may, in some search engines, include a binary logic input override to modify a search engine interpretation of the user supplied input from a default interpretation. An example of such an override may be GE72 (greater than or equal to 72) where the default interpretation by a search engine may be only equal to 72.

A search engine is comprised of a software program used in combination with a computer and some type of computer driven display whereby a person (user) seeking information from a database enters a limited amount of search criteria or input property values into an input box. For other than simple searches, there may be a multiplicity of input boxes. The lack of an input value (a null) in a given input box may be interpreted in different ways according to the design of the search engine. For the purposes of this document, a null value input box will be ignored by the search engine in generating a set of search engine criteria. The search input criteria is an abbreviated form of the typical search engine generated criteria, which will be a much longer and more complicated set of terms, thereby allowing the user to generate complex queries from simple input. The search engine takes the user entered search criteria and converts it into search engine generated criteria appropriate to the number of and the specific property value input boxes used.

It should be noted that the search performed by the search engine may be restricted to a given type of component, such as resistor, by a search engine generated set (tree) of available categories. As an example, a tree might start with the potential to search all electronic components, with various subsets including resistors, memory chips, transistors and so forth. Resistors, as an example, may be further subdivided into sub-categories of power, wirewound, precision and so forth. Thus, the user may choose the breadth of the search to be performed.

A database is comprised of one or more tables, which consist of one or more rows and one or more columns (where the intersection of a said row and column occurs being called a cell) and said columns are labeled to describe the contents of the cell. A database that is being searched may contain data in any number of cells. A plurality of cells common to or relevant to a single item, such as a resistor, may be referred to as a record. A plurality of associated cells in a record, such as those defining voltage limitations of a resistor or temperature associated values, will be referred to as component parameters. The data (or values) in each of the associated cells comprising a component parameter will be referred to as component parameter properties, such as resistor voltage property or resistor temperature property, or in unambiguous situations simply as property. The specific data inserted into a given cell, of the database, will be referred to as a property value or simply as value. This value may take the form of a number (such as 10), a string (using alphanumeric characters, such as 10 ohms), a Boolean value (such as T for true) and so forth, as appropriate to the parameter being defined.

When a database is being populated, complete information to fill each cell of a database record is not always provided. Thus, when attempting a retrieval of all records appropriate to a given situation, some records (items) are not returned because they have a null value in a given search field (input criteria) even though they may have been retrieved if a differently constructed set of search criteria had been used.

A simplified example of such a situation would be an assembly of data in a database covering electronic items obtainable from a variety of manufacturers. At least some temperature values for electronic components are typically provided by a manufacturer's sales or datasheet for use by a consumer in selecting an item that may fulfill that consumer's (user's) requirements. Values of typical operating temperature, maximum and minimum operating temperatures and maximum and minimum storage temperatures are among temperature values that may be provided by or otherwise obtained from a manufacturer.

By way of explanation as to why a minimum storage temperature could be detrimental, if a component is stored in a sealed container, such as a plastic sack, moisture precipitating from the container atmosphere could damage (and/or contaminate) some electronic components under certain very cold conditions. Alternatively, different material expansion rates of attached or otherwise mechanically connected materials used to construct an electronic component could generate enough force to damage the component with either heat or cold. Further extreme heat occurring during storage could melt some materials used in the construction of a component. For the purpose of this document, such minimum and maximum storage temperatures (or other component parameters) will be subsequently referred to as abs_min (absolute minimum) and abs_max (absolute maximum), respectively.

A given manufacturer may fail to include either one or both of minimum and maximum operating temperatures in a given datasheet for a variety of reasons, including inadvertence. Said manufacturer might still include abs_min and abs_max values along with a typ (typical operating temperature) value. If only the manufacturer supplied values are inserted in the database, a search directed to the database column containing minimum operating temperature values would not return any items in which this value was missing.

Thus, such an item, which might have other characteristics desperately desired by the requester, would not be provided (returned as a search result) for consideration.

As a specific example, it may be assumed that a database includes columns for not only the five temperature properties listed above but, additionally, a power rating field, and that the item being searched for is a resistor. It may be further assumed that the user is looking for a resistor that will operate in an environment of 100 degrees and has a power rating of at least two watts. A given power resistor supplied by a manufacturer could be included in the database as having an abs_max value of 200 degrees and a power rating of ten watts, but not have a value listed in the max (maximum operating temperature) field. It would thus not be included in the results of a search for resistors having a max temperature value of GE100 (greater than or equal to 100) AND a power value of GE2. However, the requesting user might want to use the given resistor if the user were informed about the existence of same, since the power rating is more than adequate and it thus may well be able to operate at 100 degrees, especially in view of the reduced power level requirements of the requesting user. Once the existence of such a component is known, the requesting user can seek further data from the manufacturer where it is deemed necessary.

It would thus be desirable to be able to search a database and easily retrieve not only records that meet specific search parameters, but also those additional records that are missing data entry values in specific columns but do contain data in associated cells from which one may logically infer that the additional records comply with the stated search parameters of the search field.

### SUMMARY

The foregoing disadvantages are overcome by the present invention, which comprises the method of and apparatus for retrieving all records from a sparsely populated database which may logically be inferred to coincide with a search parameter even though a given returned record does not contain data in a specifically searched cell or column of cells. This is accomplished by including any records that, while not having data in a given search cell, do have data in cells that both logically and numerically encompass the stated search parameters as well as some records that have data in non-corresponding cells but that could logically be inferred to comply with limited input search parameter property values.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a simplified representation of a user interface for entering limited inputs for retrieving records from a database in accordance with the present invention;

FIG. 2 presents an example of a plurality of sparse data records that might be found in a database along with a criteria that may be used to retrieve such a record from an indicated set of input property values;

FIG. 3 provides a combined criteria statement that may be used to retrieve records having the five component parameter properties listed from the user supplied property values shown in FIG. 2; and

FIG. 4 is a block diagram representation of a system that could be used to practice the present invention.

### DETAILED DESCRIPTION

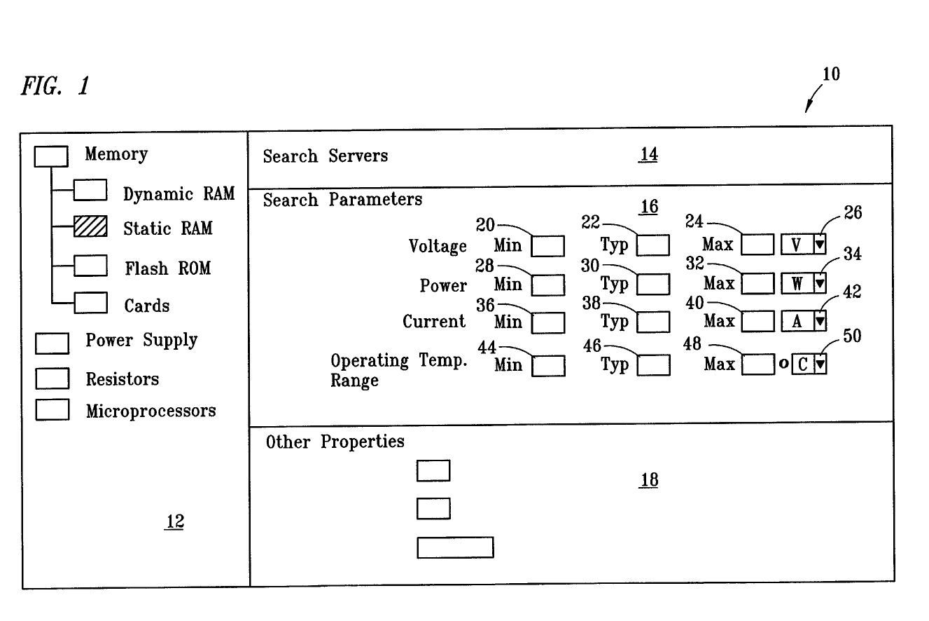

Referring to FIG. 1 of the drawings, a user interface 10 is presented whereby a user may enter search values for use by a search engine program to retrieve records appropriate to the user inserted values. Such an interface is typically a computer monitor as will be later referred to in connection with FIG. 4. To the left side of interface 10 is a component-type selection area 12 for restricting the search to less than the entire database(s). As shown by the hash-marked area, the present search is shown as being in static ram type memory components. An area 14 may be used to select one or more sources of database material, such as a local server, a corporate server, and so forth.

Specific details are not shown since the location of the database is beyond the scope of this invention. An area 16 illustrates typical search parameters that would be used in a search for electronic components. If the user were to additionally want to search for items of a non-electronic nature, such as structural steel, the search engine would present different search parameters in area 16, such as length, configuration (angle, bar, etc), composition, and so forth. A further area in this figure is designated as 18 whereby the search may be further limited. These further user inputs may be entered manually or selected from a list. An example of further inputs may be a specific manufacturer search limitation or possibly components that have the capability of operating at a given frequency.

Within area 16, a set of property value input boxes for voltage 20, 22, 24, and 26 are shown. Input box 20 has a property label of Min, while 22 and 24 have labels of Typ and Max, respectively. The box 26, as shown, is a selection box having a default unit measurement designator of V (volts). Other selectable units of selection box 26 may be millivolts and kilovolts. A set of power parameter input boxes 28, 30 and 32 for min, typ and max, respectively, are shown in like manner and having a default unit measurement designator selection box 34 of W (watts). Similar input boxes 36, 38, 40, 42, 44, 46, 48, and 50 for Current and Operating Temperature Range are designated and labeled as shown.

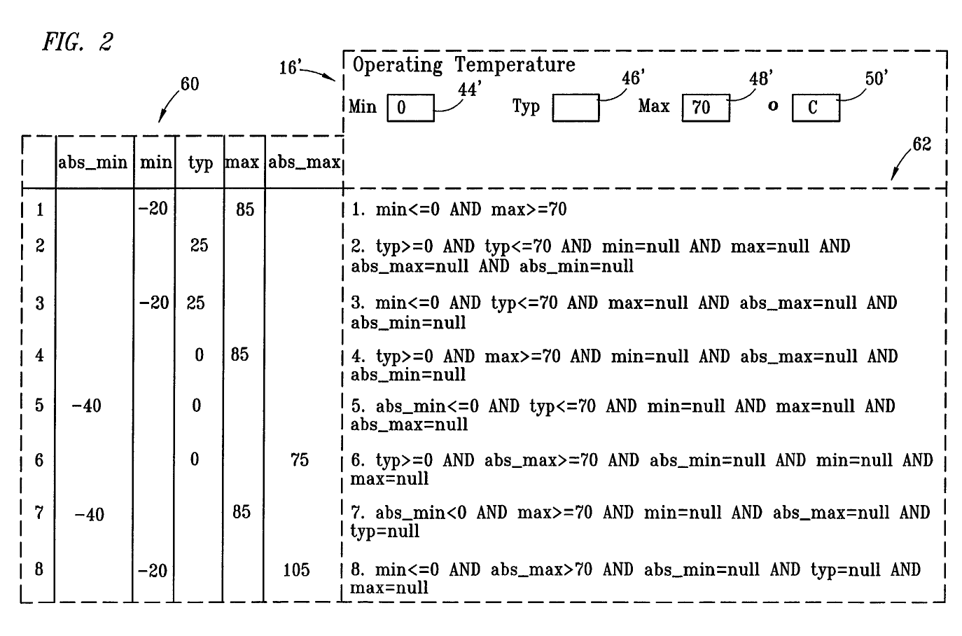

In FIG. 2, an area 16′ represents the operating temperature user input box portion of FIG. 1, with the boxes being designated with a primed number designation of their counterparts in FIG. 1. Box 44′ is shown having a user input minimum temperature value of 0 degrees C., while box 48′ has a user entered value of 70 degrees C. A dashed line enclosed area, or block 60, represents a set of cells for eight records in a portion of a database containing property values as obtained from some source, such as a manufacturer. These cells represent temperature values of abs_min, min, typ, max, and abs_max, as previously explained, and the columns of cells are labeled accordingly. The cells shown without values may be assumed to have a unique symbol representing a null or lack of entry. While a typical database would not have as many null values in eight consecutive records, as is shown in block 60, this example set is presented to help explain a portion of a criteria that would be generated by a search engine in accordance with the teachings of this invention. A further dashed line block 62 illustrates typical Boolean algebra format software terminology used to retrieve data from a database. Each term (criteria) is numbered and may be used to retrieve a like numbered record having the values (or lack of some values) shown. As will be realized by those skilled in the art, the database would have many more fields for many other parameters, as well as a means for distinguishing various types of components.

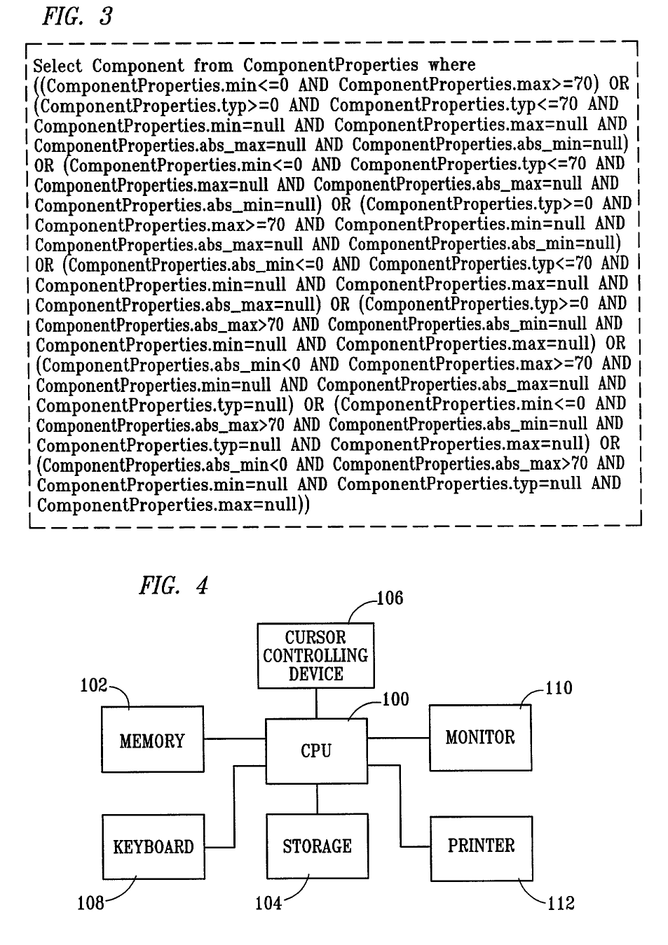

FIG. 3 illustrates a combination of all the terms of block 62 into a single criteria that may be used to retrieve all the records, in accordance with the teachings of the present invention, when a user has entered only the values shown in boxes 44′ and 48′ and used the default value of 50′. The proper use of IF-THEN statements will likely result in a criteria statement that obtains much more efficient performance from a processor. However, the present invention is independent of the approach used, whether software or hardware, to retrieve sparse data records from a database using limited inputs. While the present invention is directed to a limited input search engine, such limited input may desirably include additional operators, such as GT or ‘>’ (greater than), NE or (not equal to) and so forth. In one embodiment of this invention, the default operator assumed by the search engine in generating a criteria statement was LE (less than or equal to) for the min input box, GE (greater than or equal to) for the max input box and LE OR GE for the typ input box. When other operators are inserted, these operators are said to override the default operators.

In FIG. 4, a CPU 100 is illustrated having internal or external memory 102 and data storage 104. Storage apparatus 104 may comprise both internal and removable storage means as well as remote storage interconnected by a network (not specifically shown). Such removable or other storage means may be used to install programs and to retrieve data as well as transfer output or destination data files generated as a result of using this invention to other devices. The CPU 100 is shown being further connected to a cursor controlling device 106, such as a mouse, trackball and so forth. The CPU 100 is further connected to a keyboard 108, a monitor 110 and a printer 112 for entering commands, viewing file contents and program results and printing output, respectively. The cursor controlling device 106 may be used to select the input boxes of the display where property values are to be inserted when multiple entry boxes are to be skipped.

As indicated previously, a sparse database table is one where some of the cells of one or more records have null values. When a search is made using only a value or range of values for a given column of cells as part of a criteria statement, no records will be retrieved that have a null in the given cell. While a user that is thoroughly familiar with databases and with Boolean algebra terminology can generate a statement that will retrieve various types of records having null values, as illustrated in FIG. 2, the possibility of entering an erroneous term on the first try is very large. An attempt to retrieve records from a sparse database of multiple search parameters, such as voltage, current and temperature, drastically increases the probability of failure in creating a correct search criteria statement on the first and even within several corrective attempts. For this reason, search engines have been designed to use limited input boxes similar to that shown in FIG. 1. However, known prior art search engines have not been able to retrieve records that do not have data in cells corresponding to input boxes into which a user has inserted property values.

In order to retrieve the records having sparsely populated cells corresponding to the component parameters of interest, a set of rules needs to be formulated by which criteria may be generated. With such a set of rules, criteria may be computer generated so as to select records which have data in cells, other than those directly corresponding to input boxes containing values, from which one may logically infer that the sparse data record complies with the search requirements intended by a user. In designing a preferred embodiment of the present invention, the following seven rules were used in writing the search engine software to generate the search criteria from the limited input values provided. In the following rules, and hereinafter in this detailed description, where a value is referred to by label, an initial capital will be used for input box values and all lower case will be used for database values (Min and min, respectively, as an example).

1. If the user enters a value only in the Min field:

a. And the database record contains a value in the min cell: THEN records where the Min value entered is greater than or equal to the database min value (min<=Min) are returned in the result set (i.e. range value of the minimum value and less).

For example, if the Min value entered is 0, then all parts having a min of 0 or less are returned.

b. And the database record contains values in the abs_min AND (the typ OR max OR abs_max) cells but not in the min cell: THEN records where the Min value entered is greater than the database abs_min value (abs_min<Min<=typ) OR (abs_min<Min<max) OR (abs_min<Min<abs_max) are returned in the result set.

For example, if the Min value entered is 0, then all parts having an abs_min less than 0 AND a typ greater than or equal to 0, or an abs_min less than 0 AND a max or abs_max greater than 0 are returned.

2. If the user enters a value in the Max field:

a. And the database record contains a value in the max cell: THEN records where the Max value entered is greater than or equal to the database max value (Max<=max) are returned in the result set (i.e. range value of the max value and greater).

For example, if the Max value entered is 70, then all parts having a max of 70 or greater are returned.

b. And the database record contains values in the abs_max AND (the typ OR min OR abs_min) cells but not in the max cell: THEN records where the Max value entered is less than the database abs_max value (typ<=Max<abs_max) OR (min<Max<abs_max) OR (abs_min<Min<abs_max) are returned in the result set.

For example, if the Max value entered is 70, then all parts having an abs_max greater than 70 AND a typ less than or equal to 70 or an abs_max greater than 70 and a min or abs_min less than 70 are returned.

3. If the user enters a value in the Typ field:

a. And the database record contains values in the min AND max cells OR the typ cell: THEN records where the Typ value entered equals the database typ value (Typ==typ) OR parts in the range created by the min and max values (min<=Typ<=max) in the database are returned in the result set.

For example, if the Typ value entered is 25, then all parts with a min value less than or equal to 25 AND all parts with a max value greater than or equal to 25 OR all parts with typ value equal to 25 are returned.

b. And the database record contains values in the min AND abs_max cells OR the typ cell but not in the max cell: THEN records where the entered Typ value equals the database typ value (Typ==typ) OR parts in the range created by the min and abs_max values (min<=Typ<abs_max) in the database are returned in the result set.

For example, if the Typ value entered is 25, then all parts in the database with a typ of 25 OR parts with a min value less than or equal to 25 AND an abs_max value greater than 25 are returned.

c. And the database record contains values in the abs_min AND max cells OR the typ cell but not in the min cell: THEN records where the entered Typ value equals the database typ value (Typ==typ) OR in the range created by the abs_min and max (abs_min<Typ<=max) in the database are returned in the result set.

For example, if the Typ value entered is 25, then all parts in the database that have a typ of 25 OR parts having an abs_min value less than 25 and a max value greater than or equal to 25 are returned.

d. And the database record contains values in the abs_min AND abs_max cells OR the typ cell but not in the min AND max cells: THEN records where the entered Typ value equals the database typ value (Typ==typ) OR in the range created by the abs_min and abs_max (abs_min<Typ<abs_max) in the database are returned in the result set.

For example, if the Typ value entered is 25, then all parts in the database that have a typ of 25 OR parts having an abs_min value less than 25 and an abs_max value greater than 25 are returned.

4. If the user enters values in both the Min and Max fields:

a. And the database record contains values in the min AND max cells: THEN records where the entered Min and Max values are within the range created by the database min and max cell values (min<=Min AND Max<=max) are returned in the result set.

For example, if the Min value entered is 0 AND the Max value entered is 70, then all parts having a min value of 0 or less AND a max value of 70 or greater are returned.

b. And a database record contains a value in the typ cell only (no values are in the min, max, abs_min, and abs_max cells): THEN records where the typ value falls between the entered Min and Max values (Min<=typ<=Max) in the database are returned in the result set.

For example, if the Min value entered is 0 AND the Max value entered is 70, then all parts having a typ between 0 AND 70 are returned.

c. And the database record contains values in the min AND typ cells but not the max, abs_min, and abs_max cells: THEN records where the entered Min and Max values are between the component's cell values of min and typ (min<=Min AND (Min<=typ AND typ<=Max)) in the database are returned in the result set.

For example, if the Min value entered is 0 AND the Max value entered is 70, then all parts having a min value of 0 or less AND a typ of 70 or less AND a typ of 0 or more.

d. And the database record contains values in the typ AND max cells but not the min, abs_min, and abs_max cells: THEN records where the entered Min and Max values are between the component's cell values of typ and max (Min<=typ AND (typ<=Max AND Max<=max)) in the database are returned in the result set.

For example, if the Min value entered is 0 AND the Max value entered is 70, then all parts having a typ value of 0 or greater AND typ of 70 or less AND a max value of 70 or greater are returned.

e. And the database record contains values in the abs_min AND typ cells but not the min, max, and abs_max cells: THEN records that fall within this logical expression (abs_min<Min AND (Min<=typ AND typ<=Max)) are returned.

For example, if the Min value entered is 0 AND the Max value entered is 70, then all parts having a abs_min value less than 0 AND a typ value greater than or equal to 0 AND a typ value of less than or equal to 70 are returned.

f. And the database record contains values in the typ AND abs_max cells but not the min, abs_min, and max cells: THEN records that fall within this logical expression (Min<=typ AND (typ<=Max AND Max<=abs_max)) are returned.

For example, if the Min value entered is 0 AND the Max value entered is 70, then all parts having a typ value greater than or equal to 0 AND a typ value of less than or equal to 70 AND an abs_max value greater than 70 are returned.

g. And the database record contains values in the abs_min AND max cells but not the min, typ and abs_min cells: THEN records where the entered Min and Max values are between the component's cell values of abs_min and max (abs_min<Min AND Max<=max) in the database are returned in the result set.

For example, if the Min value entered is 0 AND the Max value entered is 70, then all parts having an abs_min value less than 0 AND a max value greater than or equal to 70 are returned.

h. And the database record contains values in the min AND abs_max cells but not the abs_min, typ and max cells: THEN records where the entered Min and Max values are between the component's cell values of min and abs_max (min<=Min AND Max<abs_max) in the database are returned in the result set.

For example, if the Min value entered is 0 AND the Max value entered is 70, then all parts having an min value less than or equal to 0 AND an abs_max value greater than 70 are returned.

i. And the database record contains values in the abs_min AND abs_max cells but not the min, typ and max cells: THEN records where the entered Min and Max values are between the component's cell values of abs_min and abs_max (abs_min<Min AND Max<abs_max) in the database are returned in the result set.

For example, if the Min value entered is 0 AND the Max value entered is 70, then all parts having an abs_min value less than 0 AND an abs_max value greater than 70 are returned.

5. If the user enters values in both the Min and Typ fields:

a. And the database record contains values in the min and typ cells but no max value: THEN records where the entered Min value is greater than or equal to the part's min and the Typ is greater than or equal to the typ (min<=Min AND Min<=typ AND typ<=Typ) in the database are returned in the result set.

For example, if the Min temperature is entered as 0 and the Typ value entered is 25, then the results set includes all devices where the min temp is less than or equal to 0 and the typ temp is greater than or equal to 25.

b. And the database record contains values in the max cell but not in the abs_min, min, typ or abs_max cells: THEN records where the entered Min value is less than the max value and the Typ value is greater than or equal to the max value (Min<max AND max>=Typ) are returned in the result set.

For example, if the Min temperature is entered as 0 and the Typ value entered is 25, then the results set includes all devices where the max temp is greater than 0 AND max temp is greater than or equal to 25.

c. And the database record contains a typ value only: THEN records where the entered Min values are less than or equal to the database typ value and the entered Typ value equals the database typ value (Min<=typ AND Typ<=typ) are returned in the result set.

For example, if the Min temperature is entered as 0 and the Typ value entered is 25, then the results set includes all devices where the typ is greater than or equal to 0 and less than or equal to 25.

d. And the database record contains values in the abs_max cell but not in the abs_min, min, typ or max cells: THEN records where the entered Min value and Typ value are less than the abs_max value (Min<abs_max>Typ) are returned in the result set.

For example, if the Min temperature is entered as 0 and the Typ value entered is 25, then the results set includes all devices where the abs_max temp is greater than 25.

6. If the user enters values in both the Typ and Max fields:

a. And the database record contains values in the typ and max cells but not the min, abs_min, and abs_max cells: THEN records where the entered Max value is less than or equal to the part's max and the Typ is less than or equal to the typ (max>=Max AND Max>=typ AND typ>=Typ) in the database are returned in the result set.

For example, if the Typ value entered is 25 and the Max value entered is 70, then the results set includes all devices where the typ temp is greater than 25 and the max temp is greater than or equal to 70.

b. And the database record contains values in the min cell but not in the abs_max, max, typ or abs_min cells: THEN records where the entered Max value is more than the min value and the Typ value is greater than or equal to the min value are returned in the result set. (Max>min AND min<=Typ).

For example, if the Typ value entered is 25 and the Max value entered is 70, then the results set includes all devices where the min value is greater than or equal to 25.

c. And the database record contains a typ value only: THEN records where the entered Typ value is greater than or equal to the database typ value and the entered Max values are greater than or equal to the database typ value are returned in the result set (Max>=typ AND Typ>=typ).

For example, if the Typ value entered is 25 and the Max temperature entered is 70, then the results set includes all devices where typ is greater than or equal to 25 AND less than or equal to 70.

d. And the database record contains values in the abs_min cell but not in the abs_max, max, typ or min cells: THEN records where the entered Typ and Max values are greater than the abs_min value are returned in the result set. (Max>abs_min<Typ)

For example, if the Typ value entered is 25 and the Max value entered is 70, then the results set includes all devices where the abs_min value is less than 25.

7. If the user enters values in Min, Typ and Max fields: The Typ field is ignored when all three fields have values. This scenario produces the same result set as rule 4.

Since rule 4 is applicable to the scenario presented in FIG. 2, this rule will be discussed in detail. The logic and application of the remaining rules will then be readily apparent to one skilled in the art of Boolean logic and computer search engine programming. It should be apparent that the discussion only applies to the situation where values are inserted solely in the operating temperature parameter input boxes. User inserted values in any of the other search parameter input boxes may well prevent any given record (of the 8 illustrated in FIG. 2) from being retrieved.

Rule 4 applies to the situation where a user inserts value into the Max and Min input boxes 48′ and 44′, respectively. As stated in 4a, all records having a component min cell value that is less than or equal to 0 and a max cell value that is greater than or equal to 70 are retrieved since the default action by design is less than or equal to for Min input box values and greater than or equal to for Max input box values. Since example record 1 has a min of −20 and a max value of 85, this record satisfies the requirements of the rule 4a and the corresponding criteria statement 1 in block 62.

As stated in 4b, all records having a component typ cell value and null values in the remaining cells should be retrieved if the value in the typ cell of the record is between the values entered in the input Min and Max fields. Since 25 is between 0 and 70, record #2 of block 60 is in accordance with equation 2 in block 62.

Rule 4c deals with the situation where there are values in the min and typ cells and the remaining cells contain a null. Since the min value of record 3 is less than the value in input box 44′ and the typ value is less than the max value inserted in box 46′, it can be logically inferred that a user may well want to consider using this component and thus this record would be returned in accordance with equation 3 in block 62.

Rule 4d addresses a similar situation where there are values in the max and typ cells and the remaining cells contain a null. Since the max value of record 4 is greater than the value in input box 48′ and the typ value is equal to the Min value inserted in box 44′, it can be logically inferred that a user may well want to consider using this component and thus this record would be returned in accordance with equation 4 in block 62.

Rule 4e is directed to a situation like that of record 5 where values are contained only in cells typ and abs_min. As set forth in this rule, where the abs_min value of record 5 is less than the value in input box 44′ and the typ value is equal to or greater than the Min value inserted in box 48′, it can be logically inferred that a user may well want to consider using this component and thus this record would be returned in accordance with equation 5 in block 62.

Rule 4f addresses a variation where there are values in the abs_max and typ cells of a record, such as shown in record 6 of block 60, and the remaining cells contain a null. Since the abs_max value of record 6 is greater than the value in input box 48′ and the typ value is less than or equal to the Min value inserted in box 44′, it can be logically inferred that a user may well want to consider using this component and thus this record would be returned in accordance with equation 6 in block 62.

Rule 4g is directed to a situation where values are contained only in cells abs_min and max. As set forth in this rule, where the abs_min value of record 7 is less than the Min value in input box 44′ and the max value is equal to or greater than the Max value inserted in box 48′, it can be logically inferred that a user may well want to consider using this component and thus this record would be returned in accordance with equation 7 in block 62.

Lastly, as concerns FIG. 2, rule 4h is directed to a situation similar to that of record 6 where values are contained only in cells min and abs_max. As set forth in this rule, where the min value of record 8 is less than (or equal to) the value in input box 44′ and the abs_min value is equal to or greater than the Max value inserted in box 48′, it can be logically inferred that a user may well want to consider using this component and thus this record would be returned in accordance with equation 8 in block 62.

Although not shown in FIG. 2, a further possible record that could be retrieved may have a value such as −55 in the abs_min field, a value such as 110 in the abs_max field and null values in the min, typ and max fields. Such a record would be retrieved in accordance with rule 4i.

The computer language essence of the statements 1-8 of block 62, along with similar language for a record conforming with rule 4i, are combined using OR operators, by the search engine, into a single statement as presented in FIG. 3. If, however, the user also inserts values in some of the other input boxes of FIG. 1, such as for example 20, 22, 30, 32 and 38, the resultant statement assembled by the search engine would, of course, be much more complicated. A search engine may apply all the criteria one time to each record or may make multiple passes. A multiple pass approach may retrieve a given subset of records using the criteria of FIG. 3 and then apply a different criteria statement developed from the values input into the voltage parameter input boxes to form a smaller subset from said given subset and so forth.

From the above discussion, it will be apparent that many different types of sparse data records may be retrieved by properly formulating the rules and resultant software. Further, the search engine software may use many different methods of applying these rules in retrieving the resulting set of records from a sparse data database. Accordingly, several variations may be made in the foregoing without departing from the spirit or the scope of the invention. One variation of the preferred embodiment described above would be to include only those sparse data records where the cell property values that do exist actually encompass the missing cell values corresponding to the values entered by the user into the input boxes. With this approach, only records 1, 7 and 8 of the examples in block 60 would be returned.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for retrieving records from a sparse data database using limited inputs, the method comprising:
a) entering at least one property value into a user interface input box;
b) generating criteria for retrieving records having fields, corresponding to the at least one user interface input box(es) containing values, containing property values as well as for retrieving at least some records having at least one database property field, corresponding to the input boxes containing values, containing a property null value; and
c) retrieving the records meeting the generated criteria.

2. The method of claim 1, comprising the additional step of outputting the retrieved records to a requesting user.

3. A method for retrieving records from a sparse data database using limited inputs, the method comprising:
a) entering at least one search property value into at least one of a set of user interface limited input boxes; and
b) generating criteria for 1) retrieving records having fields, corresponding to the user interface input boxes containing values, and which fields contain property values as well as for 2) retrieving records having at least one database property field, corresponding to the input boxes containing values, containing a property null value while having further property value fields that do contain values and which could be logically inferred to cover a range including the corresponding limited input box value.

4. Apparatus for retrieving records from a sparse data database using limited inputs, comprising:
a) means for storing database records including records that have null values in some property value fields;
b) means for entering property values into user interface input boxes;
c) means for generating criteria for retrieving records having fields, corresponding to the user interface input boxes containing values, containing property values as well as for retrieving records having at least one database property field, corresponding to the input boxes containing values, containing a property null value;
d) means for retrieving the records meeting the generated criteria; and
e) means for presenting the records retrieved to a requesting user.

5. A search engine computer program, comprising:
a) means for creating user interface input boxes for user entry of property values;
b) means for retrieving user entered property values from said user interface input boxes;
c) means for generating criteria for retrieving records having fields, corresponding to the user interface input boxes containing values, containing property values as well as for retrieving records having at least one database property field, corresponding to the input boxes containing values, containing a property null value; and
d) means for retrieving records meeting the generated criteria from a data storage facility.

6. A method for retrieving records from a sparse data database, the method comprising:
a) retrieving property values from a user interface accessible limited value input box; and
b) generating criteria for 1) retrieving records having fields, corresponding to the user interface input boxes from which search values are retrieved, containing property values as well as for 2) retrieving records having at least one database property field, corresponding to the input boxes from which search values were retrieved, containing a property null value which records have further property value fields that do contain property values and which could be logically inferred to cover a range including the corresponding limited input box from which a search value was retrieved.

7. Apparatus for retrieving records from a sparse data database using limited inputs, comprising:
a) means for accessing stored database records including records that have null values in some property value fields;
b) means for entering property value into a user interface input box;
c) means for generating criteria for retrieving records having fields, corresponding to the user interface input boxes containing values, containing property values as well as for retrieving records having at least one database property field, corresponding to the input boxes containing values, containing a property null value;
d) means for retrieving the records meeting the generated criteria; and
e) means for presenting the records retrieved to a requesting user.

8. A method of constructing a computer program for providing a search engine having limited inputs while being able to retrieve records, from a sparse data database, that do not have values in record fields corresponding to search field parameter inputs, comprising the steps of:
generating a default criteria statement, in accordance with a set of default rules, for records directly complying with user inserted values in program provided inputs;
generating a supplemental set of criteria, in accordance with a predetermined set of exception rules, for retrieving records that fail to have data in all of the fields corresponding to the inputs into which user provided values are inserted; and
retrieving records in accordance with a combination of said default and supplemental sets of criteria.

9. A search engine computer program, comprising:
a) means for providing limited input fields for receiving user inserted search values;
b) means for generating a criteria statement, in accordance with a set of default rules, for records directly complying with any user inserted search values;
c) means for generating a supplemental set of criteria, in accordance with a predetermined set of exception rules, whereby records are retrieved that fail to have data in all of the fields corresponding to the limited input fields into which user provided values are inserted; and
d) means for retrieving database stored records in accordance with a combination of said default and supplemental sets of criteria.

10. A search engine computer program, comprising:
a) means for providing limited input fields for receiving user inserted search values;
b) means for generating a set of criteria, in accordance with a predetermined set of exception rules, whereby records are retrieved that fail to have data in all of the fields corresponding to the limited input fields into which user provided values are inserted; and
c) means for retrieving database stored records in accordance with said set of criteria.

11. A method for retrieving records from a sparse data database, the method comprising:
a) retrieving property values from a user interface accessible limited value input box; and
b) generating criteria for retrieving records having at least one database property field, corresponding to the input boxes from which search values were retrieved, containing a property null value which records have further property value fields that do contain property values and which could be logically inferred to cover a range including the corresponding limited input box from which a search value was retrieved.

12. Apparatus for retrieving records from a sparse data database using limited inputs, comprising:
a) means for storing database records including records that have null values in some property value fields;
b) means for entering property values into user interface input boxes;
c) means for generating criteria for retrieving records having at least one database property field, corresponding to the input boxes containing values, containing a property null value;
d) means for retrieving the records meeting the generated criteria; and
e) means for presenting the records retrieved to a requesting user.
